(19) United States
(12) Patent Application Publication
(10) Pub. No.: US 2006/0294313 A1
(43) Pub. Date: Dec. 28, 2006

(54) System and method of remote media cache optimization for use with multiple processing units

(75) Inventors: Brooks Johnston, Cary, NC (US); Eric Richard Kern, Chapel Hill, NC (US); Tong Yu, Cary, NC (US)

Correspondence Address: DILLON & YUDELL LLP, 8911 N. CAPITAL OF TEXAS HWY.,, SUITE 2110, AUSTIN, TX, 78759, US

(73) Assignee: International Business Machines Corporation, Armonk, NY (US)

(21) Appl. No.: 11/159,687

(22) Filed: Jun. 23, 2005

(51) Int. Cl. G06F 12/00

(52) U.S. Cl. 711/129

(57) ABSTRACT

A system and method of remote media cache optimization for use with multiple processing units. The present invention discloses a data processing system that includes multiple processing units, a storage device, and a storage device adapter for coupling the storage device to the multiple processing units. The data processing system also includes a cache coupled to the storage device. The cache includes a data partition for storing data retrieved from the storage device and multiple sense data partitions. Each of the multiple sense partitions correspond to a respective one of the multiple processing units. In response to the storage device receiving a first command from a first processing unit, the storage device issues a response to the command and the storage device adapter stores sense data corresponding to the first command in a first sense data partition.

### BACKGROUND OF THE INVENTION

1. Technical Field

The present invention relates in general to the field of data processing systems. More particularly, the present invention relates to the field of multi-processor data processing systems. Still more particularly, the present invention relates to a system and method of remote media cache optimization.

2. Description of the Related Art

Many modern computer systems utilize a system interface to couple and control access to and from peripherals. An example of such a system interface is a small computer system interface (SCSI) bus or universal serial bus (USB). The SCSI and USB buses are particularly well-suited for coupling memory drives such as CD-ROM, DVD, tape, and hard disk drives. A feature common to SCSI and USB devices is a memory device that stores “sense data”. Sense data describe the state of the data stored on a storage medium or indicate the location of the read head in CD-ROM, DVD, tape, and hard disk drives.

Those with skill in this art will appreciate that many modern computer systems include multiple processing units. These multiple processing units are typically coupled to a system bus, which operates as an interconnect between the multiple processing units and the computer system's peripherals. A difficulty arises during consecutive accesses to a peripheral by two different processing units. A first access to a peripheral by a first processing unit results in a first set of sense data related to the first access. A second access to the peripheral by a second processing unit results in a second set of sense data related to the second access. After the second access, the first processing unit may query the peripheral for the first set of sense data. However, the peripheral will return instead the second set of sense data related to the second access. Therefore, there is a need for a system and method of controlling access to peripherals by multiple processing units.

### SUMMARY OF THE INVENTION

The present invention provides a system and method of remote media cache optimization for use with multiple processing units. The present invention discloses a data processing system that includes multiple processing units, a storage device, and a storage device adapter for coupling the storage device to the multiple processing units. The data processing system also includes a cache coupled to the storage device. The cache includes a data partition for storing data retrieved from the storage device and multiple sense data partitions. Each of the multiple sense partitions correspond to a respective one of the multiple processing units. In response to the storage device receiving a first command from a first processing unit, the storage device issues a response to the command and the storage device adapter stores sense data corresponding to the first command in a first sense data partition.

The above-mentioned features, as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further objects and advantages thereof, will best be understood by reference to the following detailed description of an illustrative embodiment when read in conjunction with the accompanying drawings, wherein:

FIG. 1 is a block diagram illustrating an exemplary data processing system in which a preferred embodiment of the present invention may be implemented;

FIG. 2 is a block diagram depicting an exemplary cache in which a preferred embodiment of the present invention may be implemented; and

FIG. 3 is a high-level logical flowchart illustrating a method of controlling access to peripherals by multiple processing units according to a preferred embodiment of the present invention.

### DETAILED DESCRIPTION OF THE PREFERRED EMBODIMENT

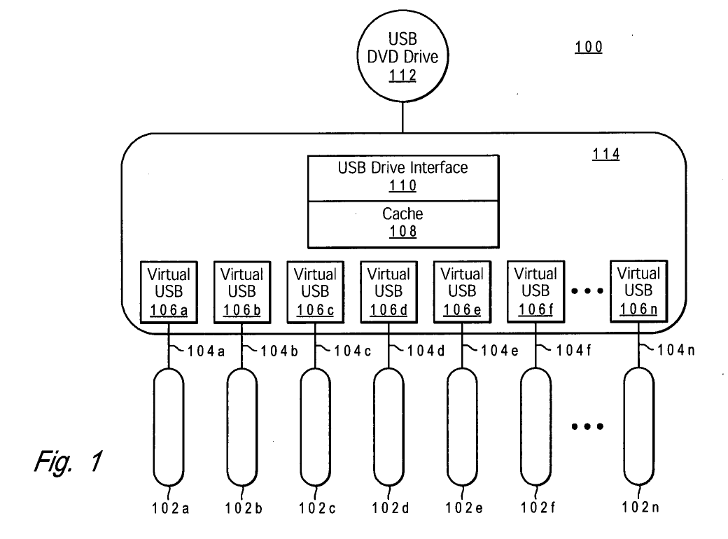

FIG. 1 is a block diagram illustrating an exemplary data processing system 100 in which a preferred embodiment of the present invention may be implemented. As illustrated, module 114 includes a collection of virtual USB connections 106a-n that couples a collection of processing units 102a-n to cache 108. Processing units 102a-n are preferably implemented as “blade servers”, which are circuit boards including at least one processor and memory. Each blade server preferably performs a dedicated task, such as servicing a web page, and may be easily inserted into a space-saving rack with many other similar blade servers. Cache 108 is coupled to USB drive interface, 110, which couples a USB peripheral such as USB DVD drive 112 to module 114. Those with skill in the art will appreciate that the USB peripheral does not necessarily have to be a DVD drive, but any USB storage peripheral may be utilized to implement a preferred embodiment of the present invention.

Those with skill in this art will appreciate that data processing system 100 can include many additional components not specifically illustrated in FIG. 1. Because such additional components are not necessary for an understanding of the present invention, they are not illustrated in FIG. 1 or discussed further herein. It should also be understood that the enhancements to the data processing system to implement access to peripherals by multiple processing units provided by the present invention are applicable to data processing systems of any system architecture and are in no way limited to the generalized multi-processor illustrated in FIG. 1.

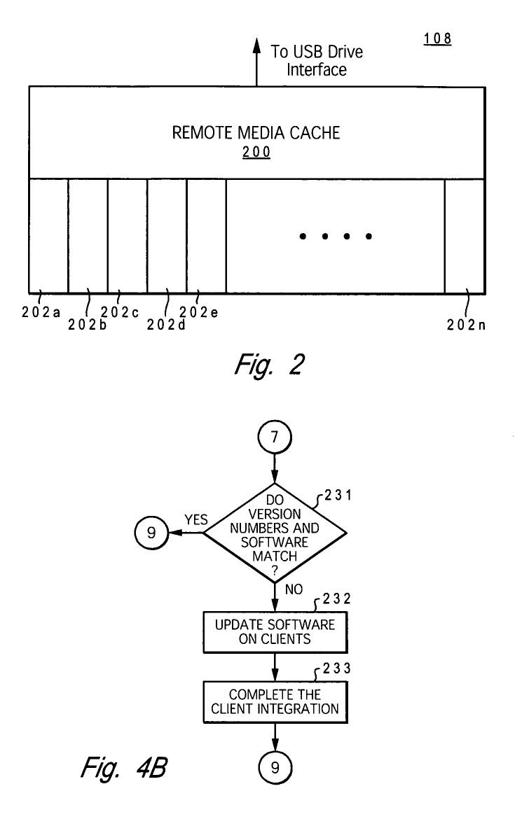

FIG. 2 is a block diagram depicting an exemplary cache 108 in which a preferred embodiment of the present invention may be implemented. As illustrated, cache 108 includes remote media cache 200 and a collection of sense data caches 202a-n (wherein the sense data caches 202a-n represent partitions within cache 108) that correspond to virtual USB connections 106a-n and processing units 102a-n. In an exemplary embodiment of the present invention, processing units 102a-n relay commands to USB DVD drive 112 to retrieve requested data. Since accesses to remote media cache 200 are many orders of magnitude faster than accesses to USB DVD drive 112, data that is retrieved from USB DVD drive 112 is cached in remote media cache 200 to enable quicker future accesses of the retrieved data.

Sense data caches 202a-n store sense data related to commands issued from processing units 102a-n. For example, processing unit 102a may issue a data read command to USB DVD drive 112. The data read command enters cache 108 via virtual USB connection 106a. USB drive interface 110 passes the data read command to USB DVD drive 112. When the requested data is sent back from USB DVD drive 112, the requested data is cached in remote media cache 200. Sense data related to the data read command issued by processing unit 102a is stored in sense data cache 202a. This preferred embodiment allows processing unit 102a to retrieve the sense data associated with the data read command at a later time, even after a second processing unit 102b has issued a second data read command requesting different data and returned sense data related to that second data read command.

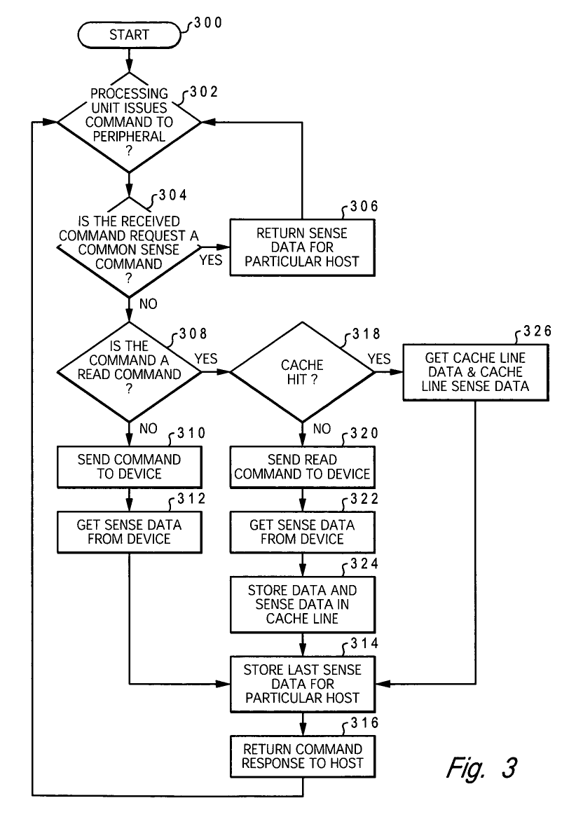

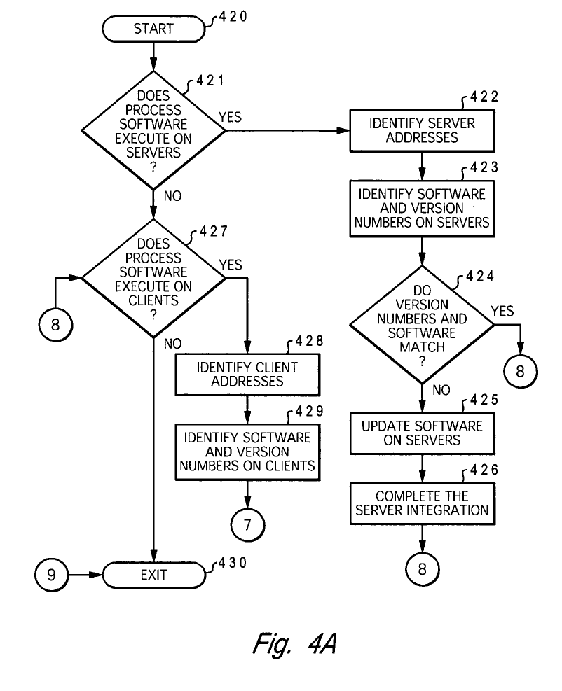

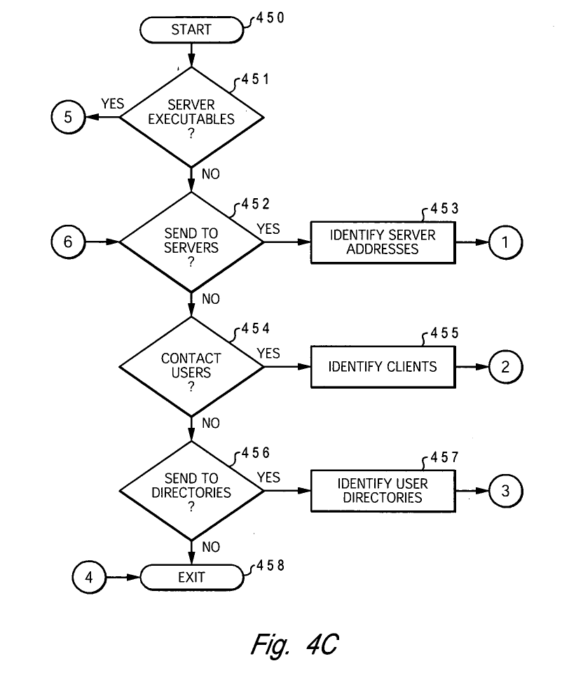

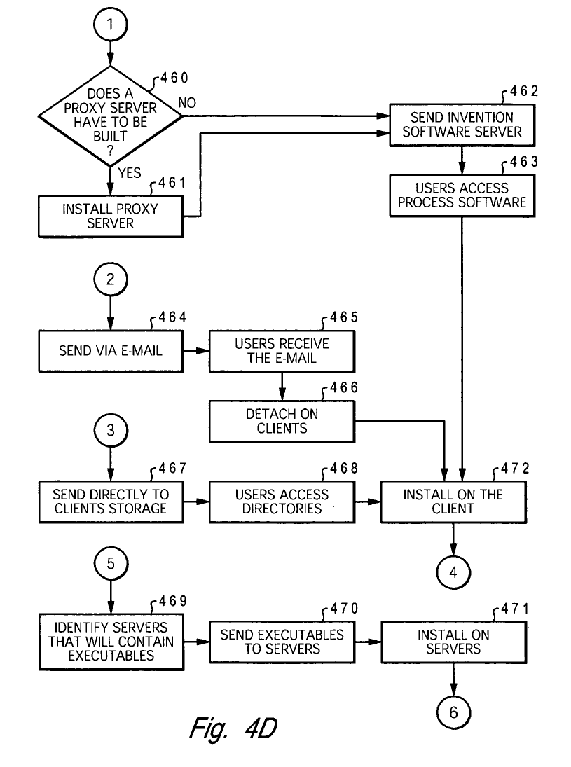

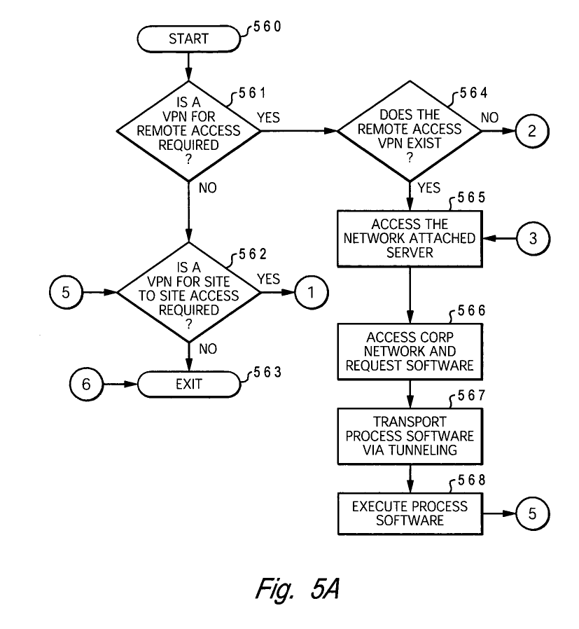

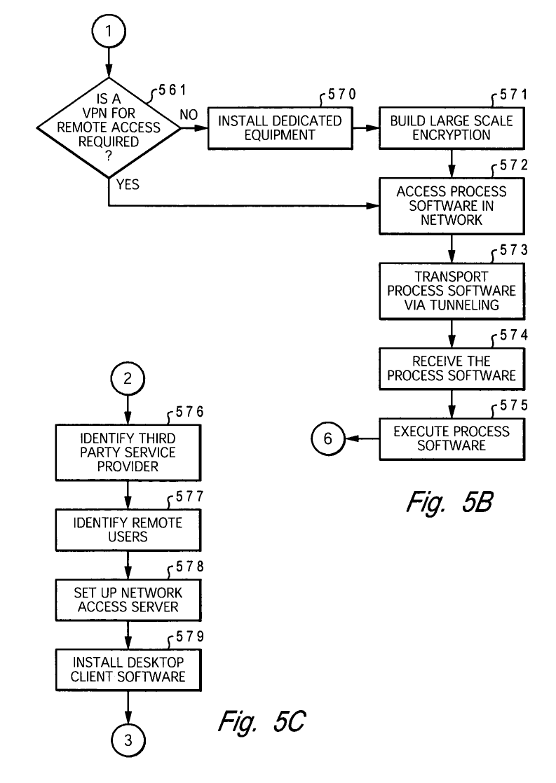

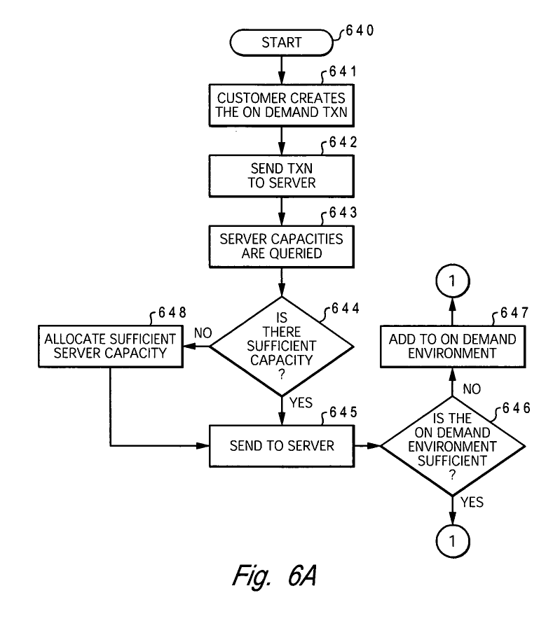

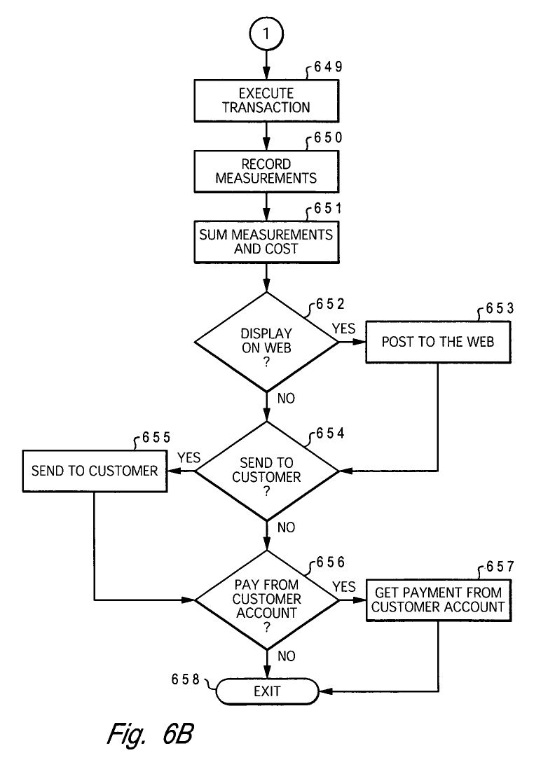

FIG. 3 is a high-level logical flowchart diagram illustrating a method of controlling access to peripherals by multiple processing units according to a preferred embodiment of the present invention. The process begins at step 300 and continues to step 302, which illustrates processing unit 102a issuing a command to USB DVD drive 112, where the command is relayed via USB drive interface 110. As previously discussed, USB DVD drive 112 may be implemented as any data storage peripheral, but is preferably a remote storage media peripheral such as (but not limited to) a CD-ROM, DVD, or tape drive.

Then, the process proceeds to step 304, which depicts USB drive interface 110 determining whether the issued command from processing unit 102a is a request for sense data. If USB drive interface 110 determines that the issued command is a request for sense data, the process continues to step 306, which depicts cache 108 returning the requested sense data stored in sense data cache 202a to processing unit 102a. The process then returns to step 302 and proceeds in an iterative fashion.

If USB drive interface 110 determines that the issued command is not a request for sense data, the process proceeds to step 308, which illustrates USB drive interface 110 determining if the issued command is a read command. If the command is determined to not be a read command, the command (which may be a write or other command) is then sent to USB DVD drive 112, where the command is processed, as depicted in step 310. The process then proceeds to step 312, which illustrates USB drive interface 110 retrieving sense data related to the command. The process then continues to step 314, which illustrates USB drive interface 110 storing the retrieved sense data in sense data cache 202a. Then, the process proceeds to step 316, which depicts, USB drive interface 110 returning the USB DVD drive's 112 response to the issued command to processing unit 102a. The process then returns to step 302 and continues in an iterative fashion.

Returning to step 308, if the command is determined to be a read command, the process continues to step 318, which illustrates USB drive interface 110 determining if the requested data exists in the remote media cache 200. If the requested data is already stored in the remote media cache 200, the process continues to step 326, which depicts USB drive interface 110 retrieving the requested data from the cache and the sense data related to the requested data. The sense data is retrieved from the sense data cache 202a-n corresponding to the processing unit 102a-n that originally retrieved the requested data from USB DVD drive 112. This ensures that processing unit 102a will always have the most updated sense data with regard to any retrieved data. The process then proceeds to step 314, which illustrates USB drive interface 110 storing the sense data related to the requested data in sense data cache 202a. The process then proceeds to step 316, returns to step 302, and proceeds in an iterative fashion.

Returning to step 318, if USB drive interface 110 determines that the requested data does not exist in the remote data cache 200, the process proceeds to step 320, which illustrates USB drive interface 110 sending the read command to USB DVD drive 112. Then, USB drive interface 100 retrieves the sense data related to the read command from USB DVD drive 112, as depicted by step 322. Then, the process proceeds to step 324, which illustrates USB drive interface 110 storing the requested data and sense data in remote media cache 200. The process then continues to step 314, which depicts USB drive interface 110 storing the sense data related to the requested data in sense data cache 202a. The process then proceeds to step 316, returns to step 302, and proceeds in an iterative fashion.

Also, it should be understood that at least some aspects of the present invention may alternatively implemented in a computer-readable medium that stores a program product. Programs defining functions on the present invention can be delivered to a data storage system or a computer system via a variety of signal-bearing media, which include, without limitation, non-writable storage media (e.g., CD-ROM), writable storage media (e.g., floppy diskette, hard disk drive, read/write CD-ROM, optical media), and communication media, such as computer and telephone networks including Ethernet. It should be understood, therefore in such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

While the invention has been particularly shown and described with reference to a preferred embodiment, it will be understood by those skilled in the art that various changes in form and detail may be made therein without departing from the spirit and scope of the invention.

Also, it should be understood that at least some aspects of the present invention may alternatively implemented in a computer-readable medium consisting of a program product, such as an emulated hardware environment. Programs defining functions on the present invention can be delivered to a data storage system or a computer system via a variety of signal-bearing media, which include, without limitation, non-writable storage media (e.g., CD-ROM), writable storage media (e.g., floppy diskette, hard disk drive, read/write CD-ROM, optical media), and communication media, such as computer and telephone networks including Ethernet. It should be understood, therefore in such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

As disclosed, the present invention provides a system and method of remote media cache optimization for use with multiple processing units. The present invention discloses a data processing system that includes multiple processing units, a storage device, and a storage device adapter for coupling the storage device to the multiple processing units. The data processing system also includes a cache coupled to the storage device. The cache includes a data partition for storing data retrieved from the storage device and multiple sense data partitions. Each of the multiple sense partitions correspond to a respective one of the multiple processing units. In response to the storage device receiving a first command from a first processing unit, the storage device issues a response to the command and the storage device adapter stores sense data corresponding to the first command in a first sense data partition.

While the invention has been particularly shown and described with reference to a preferred embodiment, it will be understood by those skilled in the art that various changes in form and detail may be made therein without departing from the spirit and scope of the invention.

What is claimed is:

1. A data processing system comprising:
a plurality of processing units;
a storage device adapter coupled to said plurality of processing units via an interconnect;
a storage device coupled to said storage device adapter via said interconnect;
a cache coupled to said storage device, said cache further comprising:
a data partition for storing data retrieved from said storage device;
a plurality of sense data partitions, each of said plurality of sense data partitions corresponding to a respective one of said plurality of processing units, wherein in response to said storage device receiving a first read command from a first processing unit of said plurality of processing units, said storage device issues a response to said first read command, and wherein said storage device adapter stores sense data corresponding to said first read command in a first sense data partition out of said plurality of sense data partitions corresponding to said first processing unit.

2. The data processing system according to claim 1, wherein in response to said cache determining that data requested by said first read command is not stored in said data partition, said storage device adapter passes said first read command to said storage device, and in response to receiving said first read command, said storage device sends said data requested by said first read command to said data partition and said first processing unit, wherein said sense data is stored in first sense data partition corresponding to said first processing unit.

3. The data processing system according to claim 1, wherein in response to said cache receiving a first read command from a first processing unit of said plurality of processing units and said cache determining that data requested by said first read command is stored in said data partition, said storage device adapter passes said data requested by said first read command to said first processing unit.

4. The data processing system according to claim 1, wherein in response to said cache receiving a first read command from a first processing unit of said plurality of processing units and said cache determining that data requested by said first read command is stored in said data partition, said storage device adapter passes said data requested by said first read command to said first processing unit and retrieves sense data corresponding to a second processing unit of said plurality of processing units that originally requested said data requested by said first read command.

5. A method comprising:
receiving a first read command from a first processing unit of a plurality of processing units;
issuing a response to said first command, in response to said receiving; and
storing sense data corresponding to said first command in a first sense data partition out of a plurality of sense data partitions corresponding to said first processing unit.

6. The method according to claim 5, further comprising:
in response to determining that data requested by said first read command is not stored in said data partition, passing said first read command to said storage device; and
in response to receiving said first read command, sending said data requested by said first read command to said data partition and said first processing unit, wherein said sense data is stored in first sense data partition corresponding to said first processing unit.

7. The method according to claim 5, further comprising:
in response to determining that data requested by said first read command is stored in said data partition, passing said data requested by said first read command to said first processing unit.

8. The method according to claim 5, further comprising:
in response to determining that data requested by said first read command is stored in said data partition, passing said data requested by said first read command to said first processing unit; and
retrieving sense data corresponding to a second processing unit of said plurality of processing units that originally requested said data requested by said first read command.

9. A computer-readable medium, storing a computer program product, comprising instructions for:
receiving a first read command from a first processing unit of a plurality of processing units;
issuing a response to said first command, in response to said receiving; and
storing sense data corresponding to said first command in a first sense data partition out of a plurality of sense data partitions corresponding to said first processing unit.

10. The computer-readable medium according to claim 9, further comprising instructions for:
in response to determining that data requested by said first read command is not stored in said data partition, passing said first read command to said storage device; and
in response to receiving said first read command, sending said data requested by said first read command to said data partition and said first processing unit, wherein said sense data is stored in first sense data partition corresponding to said first processing unit.

11. The computer-readable medium according to claim 9, further comprising instructions for:
in response to determining that data requested by said first read command is stored in said data partition, passing said data requested by said first read command to said first processing unit.

12. The computer-readable medium according to claim 9, further comprising instructions for:
in response to determining that data requested by said first read command is stored in said data partition, passing said data requested by said first read command to said first processing unit; and
retrieving sense data corresponding to a second processing unit of said plurality of processing units that originally requested said data requested by said first read command.
